(19) United States
(12) Patent Application Publication
(10) Pub. No.: US 2013/0295243 A1
(43) Pub. Date: Nov. 7, 2013

(54) METHOD FOR FORMING A LOAF OF BREAD

(71) Applicant: DAKOTA SPECIALITY MILLING COMPANY, INC., Fargo, ND (US)

(72) Inventors: Robert C. Meyer, JR., Fargo, ND (US); Wayne Flood, Tacoma, WA (US)

(21) Appl. No.: 13/932,956

(22) Filed: Jul. 1, 2013

Related U.S. Application Data
(62) Division of application No. 12/625,323, filed on Nov. 24, 2009, now abandoned.

(51) Int. Cl. A21D 13/00

(52) U.S. Cl. CPC A21D 13/0067
USPC 426/128

(57) ABSTRACT

A method of forming a loaf of bread having at least two textures is provided that includes forming a first portion of dough that corresponds to a first texture, forming a second portion of dough that corresponds to a second texture, and heating the first portion and the second portion of dough in a single bread pan to form the loaf of bread having a first end of the first texture, a second end of the second texture, and a central section having both the first texture and the second texture.

### BACKGROUND

1. Technical Field

The present disclosure relates generally to a single loaf of bread having two textures.

2. Description of the Related Art

A typical grocery store carries a variety of bread options that include, among other things, standard white, multigrain, rye, sourdough, and potato. These bread options are sold as single loaves of bread of a single flavor having a single texture throughout. The size and number of slices in these loaves of bread may vary. However, a single loaf of bread often includes around 20 slices of bread.

Since members of a household often have different bread preferences, households often purchase more than one loaf of bread. For example, adults may prefer bread with more texture such as a multigrain with whole grains, cracked grains, rolled grains, or seeds distributed throughout. In contrast, other adults in the home or children may prefer a smooth white bread with a mild flavor. Alternatively, an individual consumer may prefer to have different bread textures for different situations, such as textured bread for sandwiches and smooth bread for toast or french toast.

Households that purchase multiple loaves of bread often do not consume the entire loaf of bread before the bread becomes stale. Some loaves of bread include preservatives to increase the shelf life of the loaf of bread. However, many consumers have become more aware of the quality and ingredients in the bread products they buy. As a result, many consumers purchase naturally preserved breads that have shorter shelf lives than traditional breads. The consumers who prefer multigrain breads are usually the ones who prefer breads using natural ingredients for increasing shelf life. Compounding the problem of multiple loaves of bread expiring at different times, preservative-free breads often do not last more than a week. If a consumer buys two loaves of bread, one of each type, they will each likely go stale or moldy before they are consumed.

This practice is costly for consumers and generally wasteful. For one, consumers are paying for slices of bread that they do not consume. Also, purchasing two or more loaves of bread requires at least twice the amount of plastic or other packaging that will eventually be thrown away. In addition, manufacturers avoid producing smaller loaves of bread with fewer slices per loaf, because the smaller loaves of bread are not economically efficient for the consumer due to the level of fixed costs.

### BRIEF SUMMARY

The present disclosure is directed to a single loaf of bread having two textures so that consumers can purchase one loaf of bread and have two bread options. The loaf of bread has two textures prior to slicing, because the single, unitary loaf of bread is formed from two different dough balls that correspond to the two different textures.

In one embodiment, a first half of the loaf has a smooth texture and a second half of the loaf has a coarse texture. The first and second halves of the loaf may have the same nutritional value. For example, the first half of the loaf may be a textured multigrain and the second half of the loaf may be a milled smooth multigrain. This provides consumers with a variety of bread textures in one single loaf of bread.

In an alternative embodiment, the first and second halves of the single loaf may have different textures, different flavors, and different nutritional values. For example, the first half of the loaf may be white flour and the second half of the loaf may be multigrain.

The single loaf is baked, sliced, and packaged as a unitary loaf of bread. More particularly, the single loaf of bread is prepared using baking machinery used for traditional single texture loaves of bread. The first and second halves of the single loaf are prepared from distinct types of dough. During baking, a first portion of dough, having a first texture, merges with a second portion of dough, having a second texture. The first portion consists of a first type of dough having grain of the first texture, such as a cracked grain. The second portion consists of a second type of dough having grain of the second texture, such as a smooth sourdough. After slicing, the merging of the first and second portions creates a central portion of the bread that contains some of both types of bread.

The single loaf of bread may be transported and displayed in a package having an opening at each end so slices of both textures of the single loaf are accessible. The very same equipment for making, baking, and packing bread can be used for the single loaf of two types of bread as used for the standard loaf. This new bread product provides consumers with bread options in consumable portions. Consumers who currently purchase two loaves of bread but do not consume all of the bread before it goes stale can have bread variety without wasting bread. In addition, the amount of packaging required to provide bread options to a consumer or a household is reduced.

### BRIEF DESCRIPTION OF THE SEVERAL VIEWS OF THE DRAWINGS

The foregoing and other features and advantages of the present disclosure will be more readily appreciated as the same become better understood from the following detailed description when taken in conjunction with the accompanying drawings, wherein:

FIG. 1 illustrates an isometric view of a loaf of bread having two textures;

FIG. 2 illustrates a cross-sectional view of the loaf of bread of FIG. 1;

FIG. 3 illustrates a top view of the loaf of bread of FIG. 1 in a package having two openings;

FIGS. 4, 5, and 6 illustrate a sequence of forming an alternative embodiment of a loaf of bread of the present disclosure; and

FIG. 7 illustrates a loaf of bread in a package having two openings with indicia that correspond to two different textures.

### DETAILED DESCRIPTION

In the following description, certain specific details are set forth in order to provide a thorough understanding of various embodiments of the disclosure. However, one skilled in the art will understand that the disclosure may be practiced without these specific details. In some instances, well-known structures associated with the baking, slicing, and packaging of bread have not been described in detail to avoid obscuring the descriptions of the embodiments of the present disclosure.

Unless the context requires otherwise, throughout the specification and claims that follow, the word “comprise” and variations thereof, such as “comprises” and “comprising,” are to be construed in an open, inclusive sense, that is, as “including, but not limited to.”

Reference throughout this specification to “one embodiment” or “an embodiment” means that a particular feature, structure or characteristic described in connection with the embodiment is included in at least one embodiment. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

In the drawings, identical reference numbers identify similar features or elements. The size and relative positions of features in the drawings are not necessarily drawn to scale.

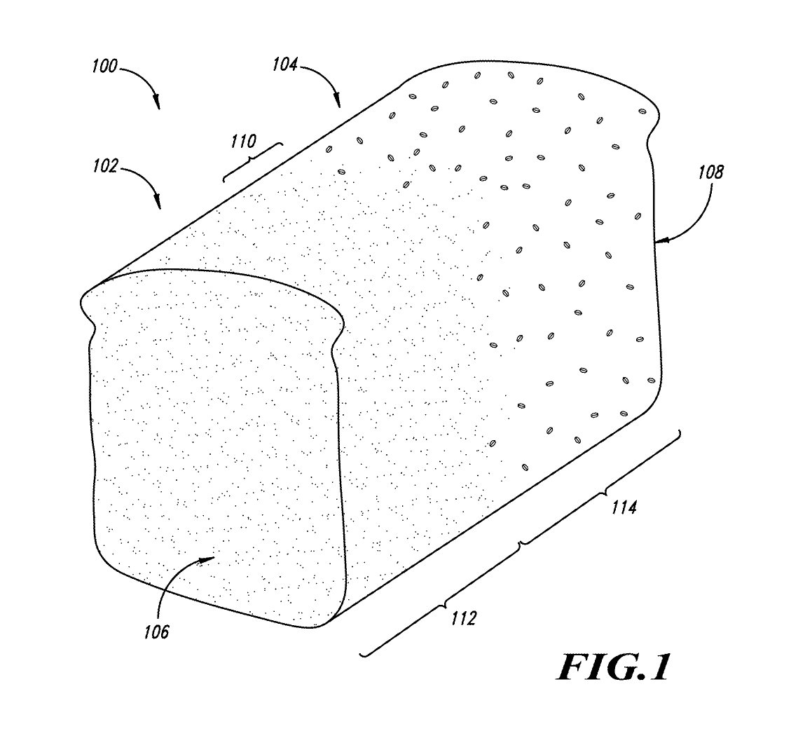

Referring to FIG. 1, a pre-sliced loaf of bread 100 is illustrated having a first texture 102 and a second texture 104. The loaf of bread 100 may be formed using traditional baking machinery, such as in a commercial bread making facility, so that the loaf of bread 100 having two textures 102, 104 is equal in length and width to a traditional single texture loaf of bread.

The loaf of bread 100 is formed from a first portion of dough that corresponds to a first half 112 of the loaf of bread 100 and a second portion of dough that corresponds to a second half 114 of the loaf of bread 100. The first and second portions of dough are placed in a baking pan, with sufficient space between them to ensure adequate space to rise and expand. During baking, the first and second portions of dough expand away from each other to form a first end 106 that corresponds to only the first texture 102 and a second end 108 that corresponds to only the second texture 104. In addition, the first and second portions of dough expand towards each other to form a central section 110 of the loaf of bread 100 that includes both the first texture 102 and the second texture 104.

In FIG. 1, the first texture 102 is illustrated as a smooth even consistency throughout the first half 112. The smooth consistency may be achieved by using fully milled grains having an even texture throughout. The fully milled flour may be ground, milled, or otherwise processed until it is a fine powder, such as traditional white flour. Of course, multigrain compositions may be used that have been sufficiently milled to form a powder that is consistent. Dough made from fully milled grains will have a smooth texture while retaining the nutritional value. Fine flour, which can be termed smooth, powder, fully milled, or other such terms can be composed of any type of grain or combination of grains, nuts, or other food. For example, a multigrain flour can be composed of hard winter red wheat, oats, buckwheat, rye, corn, millet, and the like. Each of these grains is fully milled to a smooth powder and then appropriate ratios mixed to create the desired multigrain flour. The texture is still smooth, similar to standard white bread because fully milled fine flour was used. The color will not be white since various grains, unbleached of different colors are used, but the texture will be smooth.

In contrast, the second texture 104 of second half 114 of the loaf of bread 100 is illustrated as having whole grains in various forms, such as cuts, flakes, or whole kernels, dispersed throughout. The second texture 104 may be a coarse texture that is traditionally associated with a multigrain bread. The coarse texture may include a plurality of grains such as oats, cracked wheat, buckwheat, barley, millet, rye, amaranth, quinoa, corn, and flax to name a few. In addition, the grains may include the whole seed, i.e., the germ, the bran and the endosperm sections. The term coarse is intended to include textures in breads such as cracked wheat, rolled oats, crunchy breads, and partially ground or partially milled grains. Thus, the differences between the two halves of the loaf may be solely based on whether all the grains therein are fully milled, which is a smooth texture, or partially milled, which is a coarse texture. More particularly, both the first half and the second half of the loaf of bread 100 will include whole seeds, i.e., the germ, the bran and the endosperm sections mentioned above. The difference between the first half and the second half will be that the whole seeds will be milled into different textures. The grain content will be the same, with the same nutritional content.

The present disclosure is not limited to strictly a smooth texture for the first texture 102 and a hard or crunchy texture for the second texture 104. Any number of combinations of bread flavors and textures may be combined into a single loaf of bread in accordance with the process disclosed. For example, the first half 112 may be a smooth version of the same grains included as the second texture 104 in the second half 114 of the loaf of bread 100. A central region 110 will have a blend of both types of bread. A grain combination may be selected by a baker for a specific nutritional value. Two different bread flours may be prepared from the same grain combination. The first bread flour may be processed to achieve the smooth first texture 102 of the loaf of bread 100. The second bread dough may include an unmilled or slightly milled part of the grain combination to create the second texture 104 of the loaf of bread 100. In this case the two halves 112, 114 of the bread 100 will have the same nutritional value with different textures.

Of course, the two halves of bread may have different grains and flours. For example, one half can be a sourdough and the other half whole wheat, or half soft white wheat and the other half a combination of oats, such as hard winter red wheat and other grains. In these cases, the halves of the loaf will be different nutritional value. The specifics of preparation of the two balls of dough, including specific combinations of ingredients, are standard and well known in the prior art and therefore need not be described herein. The dough may be prepared in accordance with various recipes well known to bakers. Flour, liquid, whether water or milk, yeast, sugar, salt and other ingredients normally used in any of the well-known bread recipes are combined in individual balls of dough. The mixing and kneading are performed as well known for each particular loaf recipe. For example, a multigrain may include any number of grains to achieve a desired nutritional or flavor balance. In addition, nuts, raisins, or other dried fruit may be included to impact the texture or flavor. The two portions of dough should have similar temperature and time for the baking process to ensure even cooking and a consistent shape.

Although illustrated as halves in the Figures, the two portions of dough may be different sizes, i.e., a ratio of the first portion of dough to the second portion of dough may be variable. It is beneficial if both have approximately the same size after baking. Since some dough rises more than others and respond to yeast differently, the dough portions, before rising, may have different sizes so that after rising and being fully baked, the loaf of bread has approximately the same shape for its entire length, as shown in the figures.

As described above, once the two portions of dough are ready for baking, traditional baking machinery for single texture loaves of bread may be utilized to bake the loaf of bread 100. The first and second textured portions of dough are placed in a bread pan and sufficiently spaced to allow each portion to rise and expand during baking. In one embodiment, the first and second portions of dough will each individually equal about one quarter of the volume of the baking pan before they rise. Therefore, the first and second portions together will equal approximately one half of the volume of the bread pan. This proportion will allow the loaf of bread 100 to dome evenly instead of mushroom over edges of the baking pan.

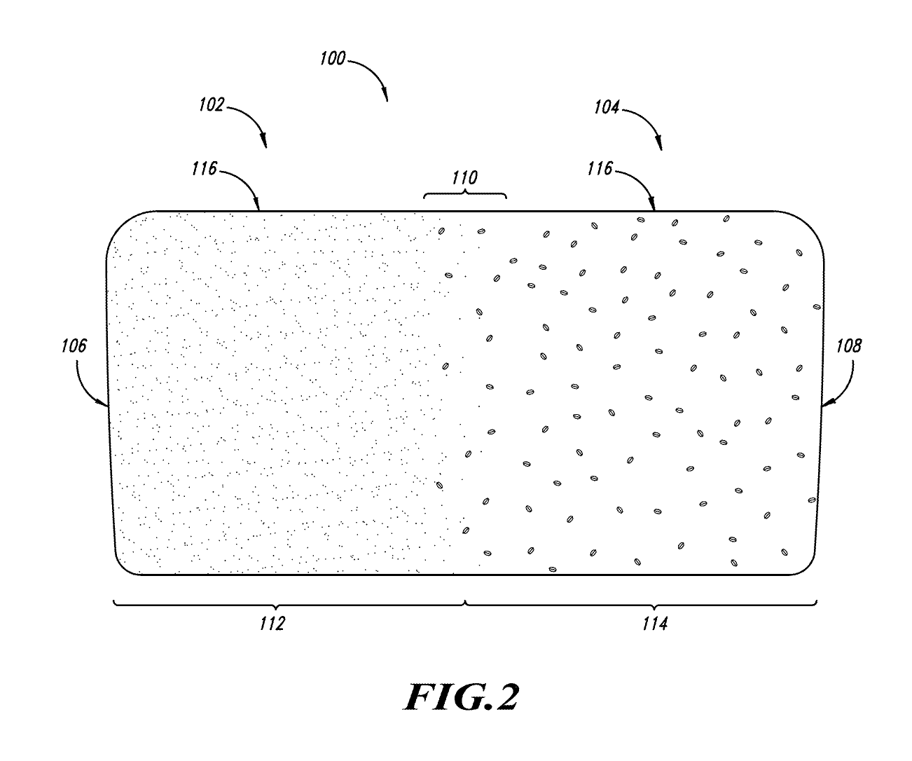

FIG. 2 is a cross-section of the pre-sliced loaf of bread 100 in FIG. 1. The smooth first texture 102 and the crunchy second texture 104 are clearly illustrated in this cross-section. During baking, the first and second portions of dough rise and expand towards each other until the first and second textures 102, 104, respectively, merge to form the central section 110. If the two portions of dough are not equal, the central section 110 may not be aligned with the center line of the loaf of bread 100, but this is acceptable.

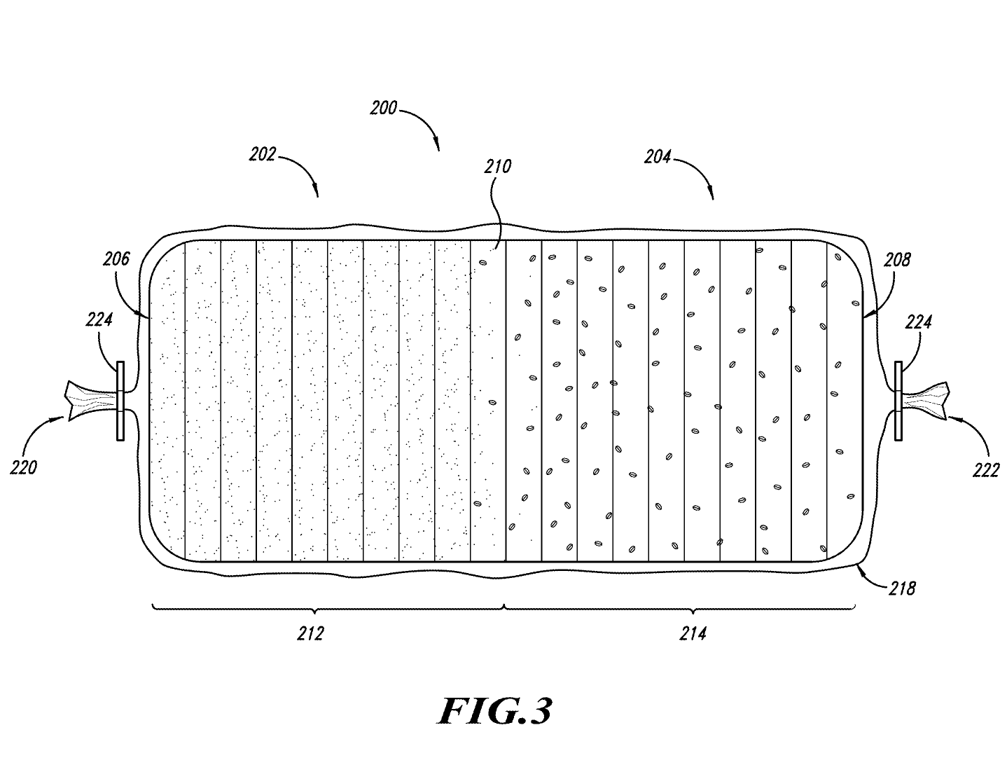

A top surface 116 of the loaf of bread 100 is illustrated as substantially flat such that the first half 112 and the second half 114 of the loaf of bread 100 merged to form a perfectly smooth top surface 116. However, the top surface 116 may have a depression or some other irregularity where the two halves 112, 114, respectively, merge. FIG. 3 illustrates a sliced loaf of bread 200 having a first texture 202 at a first end 206 and a second texture 204 at a second end 208. The loaf of bread 200 is formed according to the present disclosure to be baked as a single loaf of bread having two textures, 202, 204. After the loaf of bread has been baked and sufficiently cooled, the loaf of bread 200 is sliced into a preselected number of slices that can vary based on the size of the loaf and the desired thickness of the slices. At least one central slice 210 of the loaf of bread 200 will contain some of the first texture 202 and the second texture 204.

In one embodiment, the two balls of dough abut each other when placed in the pan, prior to rising and before baking. This will assist them to merge fully into a contiguous, unitary loaf as they each rise and press into each other.

FIG. 3 includes a package 218 having a first opening 220 at one end and a second opening 222 at the other end to allow a consumer to have equal access to either the first texture 202 of a first half 212 or the second texture 204 of a second half 214. After slicing, each half 212, 214 of the bread will contain different textures 202, 204, respectively, so the user may choose the type of bread they wish by selecting which end of the loaf to use.

The package 218 may be made of a flexible plastic material that is lightweight and sufficiently air tight to keep the loaf of bread 200 fresh. By using a flexible plastic, the size of the packaging 218 can be adjusted as slices of bread are removed and consumed. Any one of a variety of ties 224 may be provided at each end to securely close each opening 220, 222 of the package 218. The ties include any type of closure mechanism, such as clasps, clip locks, Kwik Loks®, twists, wire ties, and the like. The package has pre-formed openings 220 and 222 at each end as the package is provided. The ends are closed with the ties 224 to keep the bread fresh and can be easily opened by removing tie 224 then closed again by replacing tie 224.

The single loaf of bread 200 is baked, sliced, and packaged as a unitary loaf of bread. This single loaf of bread 200 having two textures may be displayed in the package 218 that provides easy opening at each end so that both portions of the bread are accessible.

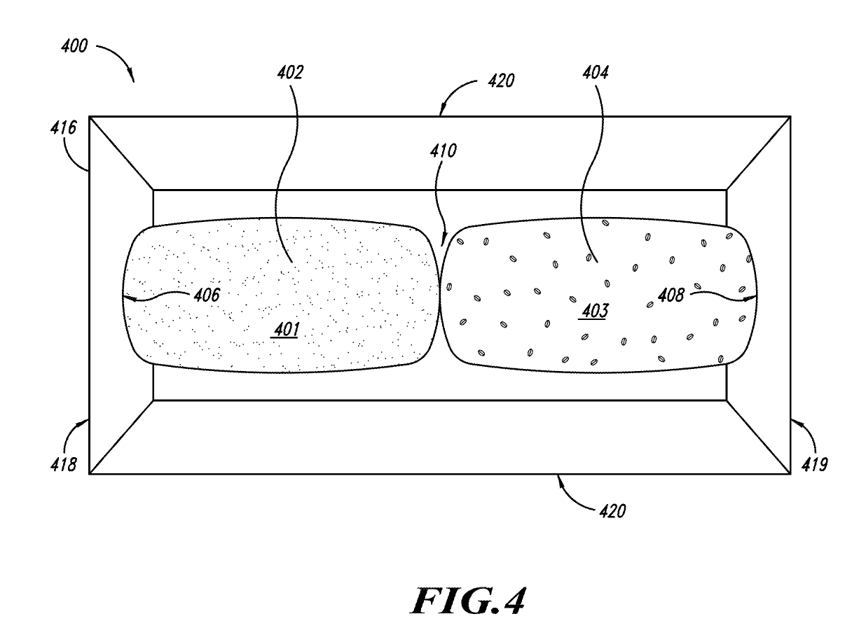

FIGS. 4, 5, and 6 illustrate a method of manufacturing a single loaf of bread 400 having a first texture 402 and a second texture 404. In FIG. 4, a first type of dough 401 having the first texture 402 is placed in a baking pan 416. A second type of dough 403 having the second texture 404 is placed in the baking pan 416 abutting the first type of dough 401. The first type of dough 401 has a first end 406 and a second end 407. The second type of dough 403 also has a first end 408 and a second end 409. The first end 406 of the first type of dough 401 abuts a sidewall 418 of the baking pan 416. In addition, the first end 408 of the second type of dough 403 abuts an opposing sidewall 419 of the baking pan 416. The second end 407 of the first type of dough 401 abuts the second end 409 of the second type of dough 403 to form a seam 410.

The baking pan 416 is rectangular in shape and has the sidewalls 418, 419 against which the first end 406 of the first type of dough 401 and the first end 408 of the second type of dough 403 abut. In addition, the baking pan 416 has elongated walls 420 that are parallel to a central axis along which the first type of dough 401 and the second type of dough 403 are placed. When the first and second types of dough 401, 403 are placed in the baking pan 416, there is a space between edges of the first and second types of dough and the sidewalls 420.

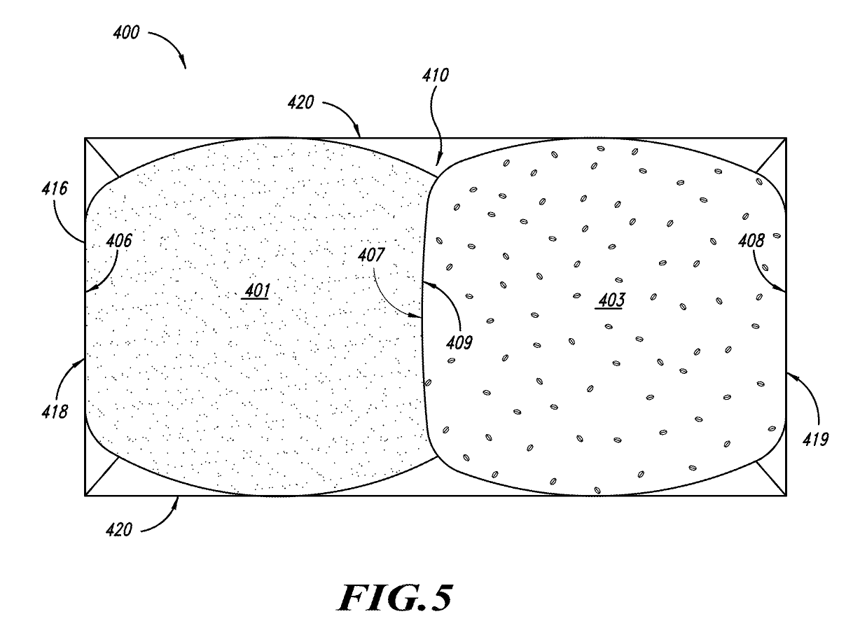

As can be seen in FIG. 5, the first type of dough 401 and the second type of dough 403 rise and expand within the baking pan 416. The first and second types of dough 401, 403 expand to abut the sidewalls 420 as well as the sidewalls 418, 419. After the dough has sufficiently risen, the first portion of dough 401 and the second portion of dough 403 are substantially similar heights.

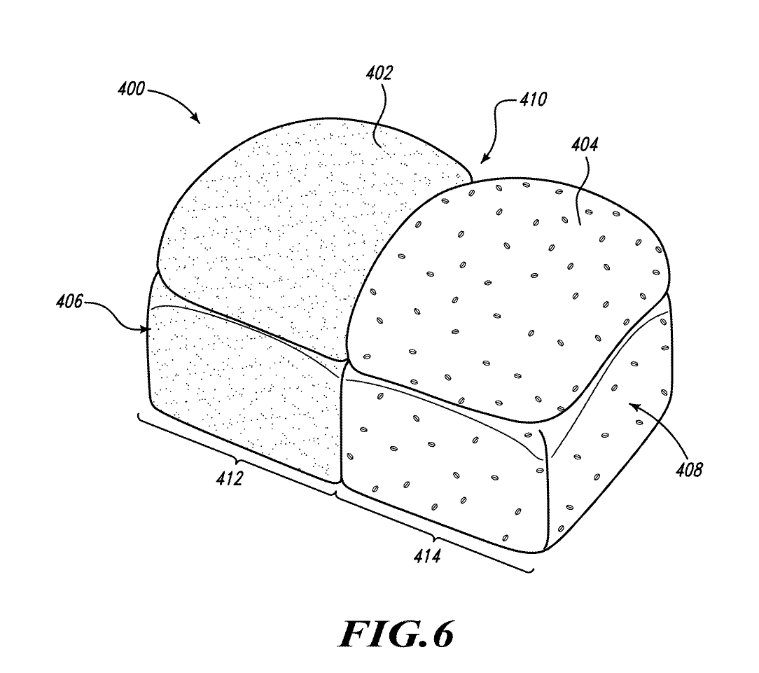

The single loaf of bread 400 is ready to be baked once the first portion of dough 401 and the second portion of dough 403 have sufficiently risen. FIG. 6 illustrates the single loaf of bread 400 after the baking process and after the bread has been removed from the baking pan 416. The first half 412 corresponds to the first texture 402 of the first type of dough 401. In addition, the second half 414 corresponds to the second type of dough 403 of the second texture 404. The bottom portion of the loaf of bread 400 is substantially planar and corresponds to the sidewalls 418, 419, and 420 of the baking pan 416. The seam 410 separates the first half 412 from the second half 414 from an exterior point of view. However, slicing through the bread 400 will show a blending or merging of the first type of dough 401 and the second type of dough 403.

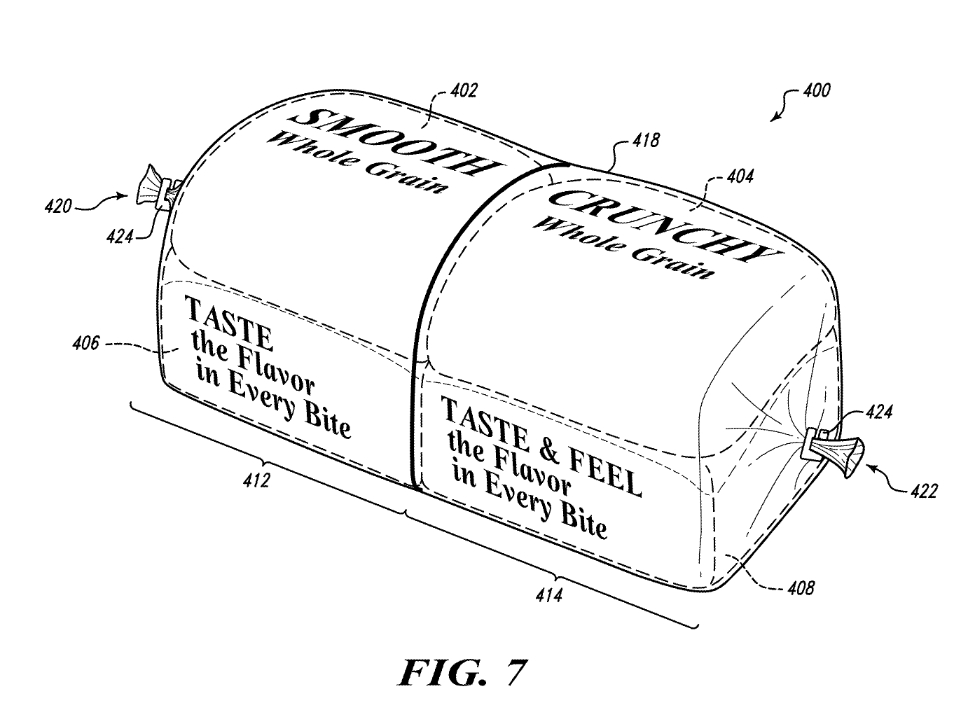

FIG. 7 illustrates a loaf of bread 400 formed in accordance with the method of manufacture described above with respect to FIGS. 4, 5, and 6. The loaf of bread 400 is sliced and then placed in a package 418 that has a first and second pre-formed opening 420, 422 at opposing ends of the package 418. The ends are closed with ties 424 to keep the bread fresh and can be easily opened by removing tie 424 then closed again by replacing tie 424. The slices are not illustrated in this figure in order to avoid detracting from the features of the package 418.

The first opening 420 provides direct access to slices of the first half 412 of the first texture 402 and the second opening 422 provides direct access to the second half 414 of the second texture 404. A consumer may choose the type of bread they wish by accessing that half through the respective opening. The package 418 clearly indicates a distinction between the two halves of bread 412, 414 of different textures 402, 404 contained in the package 418. A demarcation line is located at a central location of the package 418 that may correspond to the seam 410 between the first half 412 and the second half 414 of the loaf of bread 400.

The package 418 may be made of a flexible plastic material that is lightweight and sufficiently air tight to keep the loaf of bread 400 fresh. By using a flexible plastic, the size of the packaging 418 can be adjusted as slices of bread are removed and consumed. Any one of a variety of ties 424 may be provided at each end to securely close each opening 420, 422 of the package 418. The ties include any type of closure mechanism, such as clasps, clip locks, Kwik Loks®, twists, wire ties, and the like.

Indicia on the package 418 that correspond to each opening 420, 422 notifies a consumer of the two different textures 402, 404 of the two halves 412, 414 of the loaf of bread 400. For example, the first texture 402 of the first half of bread 412 may be formed of a milled smooth multi-grain and the second texture 404 of the second half of the bread 414 may be formed of a coarse multi-grain. Accordingly, the indicia on the package 418 may include language, such as, “Smooth Whole Grain” and “Taste the Flavor in Every Bite” that corresponds to the smooth multigrain of the first texture 402. In addition, the package 418 may include language, such as “Crunchy Whole Grain” and “Taste and Feel the Flavor in Every Bite” on the package 418 that corresponds to the coarse multi-grain of the second texture 404. This language is provided as an example and any language that describes the different type of bread texture that corresponds to the respective opening is sufficient.

In one embodiment, the first half 412 and the second half 414 may be formed with that same nutritional value where the grain for the first half 412 is milled until smooth and the grain for the second half 414 only partially milled. Alternatively, the two halves of bread 412, 414 may have different nutritional values. For example, the first half 412 may be formed from smooth white flour while the second half 414 is formed from multigrain with sunflower seeds incorporated throughout. In this example, the package 418 may include language such as “Smooth White Bread” corresponding to the first smooth white half and “Multigrain Bread with Sunflower Seeds” corresponding to the second multigrain half.

The various embodiments described above can be combined to provide further embodiments. These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not to be limited by the disclosure.

1. A package and loaf of bread combination, comprising:
the loaf of bread having a first texture for approximately a first half of the loaf of bread;
the loaf of bread having a second texture for approximately a second half of the loaf of bread;
the loaf of bread having a third portion centrally located in the loaf of bread having some of the first texture and some of the second texture;
the package encloses the loaf of bread, the package having a first pre-formed opening in a first end and a second pre-formed opening in the second end, the first and second opening providing the same access to the first half of the bread as to the second half of the bread;
a first clasp at the first end of the package configured to close the first end when the clasp is present and configured to allow the first opening to be open when the clasp is not present at the first opening; and
a second clasp at the second end of the package configured to close the second end when the clasp is present and configured to allow the second opening to be open when the clasp is not present at the second opening.

2. The package and loaf of bread combination of claim 1 wherein the package is formed of a flexible plastic film that is tubular in shape.

3. The package and loaf of bread combination of claim 2 wherein the flexible plastic film is configured to conform to a shape of the loaf of bread.

4. The package and loaf of bread combination of claim 1 wherein the first and second clasps are configured to close the package at a plurality of locations along a length of the package different from the first opening at the first end and the second opening at the second end.

5. The package and loaf of bread combination of claim 1 wherein the package and the first and second clasps enclose a first volume when the first and second clasps are positioned on the package at the first opening at the first end and at the second opening at the second end, respectively.

6. The package and loaf of bread combination of claim 5 wherein the package and the first and second clasps are configured to form a plurality of second volumes when the first and second clasps are positioned one the package at a plurality of locations along a length of the package, the first volume being larger than each of the plurality of second volumes.

7. A product, comprising:
a single, unitary loaf of bread having:
a first portion having a first texture;
a second portion having a second texture, the first and second portions being accessible from different ends of the loaf of bread, the loaf of bread having a bottom, a top, a left end, and a right end, the left end having the first texture and the right end having the second texture, the bottom and top including both the first and second texture, the first texture being distinct from the second texture;
a package having a tubular portion between a first opening and a second opening, the tubular portion configured to contain the loaf of bread, the first portion being accessible from the first opening and the second portion being accessible from the second opening.

8. The product of claim 7 wherein the first texture is made from a selected combination of grains having a nutritional content and the second texture is made from the same selected combination of grains and having the same nutritional content as the first portion.

9. The product of claim 7 wherein the first texture is formed from a fine smooth flour and the second texture is formed from a coarse flour having partially milled or unmilled grains.

10. The product of claim 7 wherein the first texture is from a first combination of grains and the second texture if from a second combination of grains.

11. The product of claim 10 wherein the first combination of grains and the second combination of grains are different combination of grains having different nutritional values.

12. A loaf of bread and package combination, comprising:
a top surface of the loaf of bread;
a bottom surface of the loaf of bread;
a first portion of the loaf of bread accessible from a first end, the first portion having a first texture formed from a combination of grains having a nutritional content;
a second portion of the loaf of bread accessible from a second end that is opposite from the first end, the second portion having a second texture formed from the same combination of grains as the first portion and having the same nutritional content as the first portion of the loaf;
a third portion centrally located in the loaf of bread having some portion of the first texture and the second texture, the top and bottom surface of the loaf of bread including some of the first, the second, and the third portion of the loaf of bread;
the package having a tubular portion between a first opening and a second opening, the tubular portion configured to contain the loaf of bread, the first portion being accessible from the first opening and the second portion being accessible from the second opening;
a first clasp positioned around the package to seal the first opening; and
a second clasp positioned around the package to seal the second opening.

13. The combination of claim 12 wherein the first texture is formed from a fine smooth flour and the second texture is formed from a coarse flour having partially milled or unmilled grains.

14. The combination of claim 12 wherein the package is clear plastic.
